(19) United States
(12) Patent Application Publication
(10) Pub. No.: US 2005/0089627 A1
(43) Pub. Date: Apr. 28, 2005

(54) Method of obtaining protective coatings on the surface of chemically active materials

(76) Inventor: Konstantin Chuntonov, Migdal Ha Emek (IL)

Correspondence Address: BAKER & BOTTS, 30 ROCKEFELLER PLAZA, NEW YORK, NY, 10112, US

(21) Appl. No.: 10/792,125

(22) Filed: Mar. 3, 2004

Related U.S. Application Data
(63) Continuation of application No. PCT/AT02/00195, filed on Jul. 5, 2002.

(30) Foreign Application Priority Data
Oct. 8, 2001 (AT) A1585/2001

(51) Int. Cl. B05D 5/06

(52) U.S. Cl. 427/58; 427/430.1

(57) ABSTRACT

The invention is concerned with a method of obtaining protective coatings on the surface of chemically active materials comprising a mixture of a chemically active metal and a fusible stable element. The method is characterized by comprising the steps of: providing at least one chemically active metal A providing at least one fusible stable element B mixing metal A and element B to form a mixture treating said mixture at its surface with a liquid agent L, which is capable of dissolving metal A but not capable of dissolving element B, at a temperature which is higher than the melting point of element B thereby creating a coating consisting essentially of element B at the surface of said mixture ceasing treatment when the desired thickness of the coating has been achieved removing the liquid agent and cleaning and drying the mixture.

The present invention is concerned with a method of obtaining protective coatings on the surface of chemically active materials comprising a mixture of a chemically active metal and a fusible stable element.

Most metallic materials are prone to corrosion and need protection from the environmental impact. This is especially important in the case of active metals, which are quickly destroyed even at a short contact with the ordinary atmosphere. The problem of overcoming high chemical activity of Li, Na, K, Rb, Cs, Mg, Ca, Sr, Ba, Ra, La, Pr, Er, Eu, Yb, U, Pu and some other metals, e.g., Ti, appears at almost all the stages of their treatment and use.

Either full isolation of the material from the environment via coatings or hermetic shells or partial decrease of the metal reactivity via mixing it with another specially selected component is used as means of protecting metals from the harmful influence of the atmosphere and moisture. The choice of the protection method depends on the requirements to the material at a given stage of its usage.

Well developed methods of protective coatings deposition from vapor or liquid phase, like physical or chemical deposition, spraying, sputtering, plating, enamel covering, oxidation, nitriding, etc. appeared to be inapplicable in the case of active metals exactly due to their high chemical reactivity. That is why at present time while working with active metals there are two methods of protecting material from environment: In hermetic shells like metal containers or glass ampoules and in mixtures of active metals with other substances.

The first method is reliable at the stage of storage and transportation of an active material but needs special tools for breaking a shell, thus it does not provide fine dosage of the delivered metal. The second method is better adjusted to handling the material at the usage stage, when the main requirement to a source of an active metal becomes the requirement of controllability of the process of releasing this metal, however, it also has serious drawbacks.

Thus, in Alkali Metal Dispensers [Della Porta P., Rabusin E. U.S. Pat. No. 3,579,459, 1971] or in barium evaporable getters [Ferrario B. Vacuum, 1996, 47,363] vapors of an active metal A appear as a result of a reaction, which takes place in powders 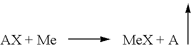
where AX is an inorganic compound (e.g. chromates or dichromates) or intermetallic compound (e.g., Al₄ Ba) of metal A, Me is a reducing agent, A↑—a target vapor. Disadvantages of this kind of vapor sources are the hygroscopic property of AX, gassing during evaporation, exothermic character of reaction, carcinogenicity of chrome compounds, etc.

For producing metal vapor of A it was also suggested to use the thermal decomposition of intermetallic compounds 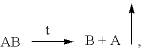
where AB is an intermetallic powder or a melt of composition AB, B is the second component. The advantage of the given sources is that they allow precise control over the evaporation flow by changing time and the temperature of thermolysis [Van Vucht J. H. N., Fransen J. J. B. U.S. Pat. No. 3,945,949, 1976; Hellier S. J. U.S. Pat. No. 4,195,891, 1980]. However, the sources of the given type did not become widely spread because the chemical activity of intermetallics AB, especially in a powder form, remains on a high level.

Processes of another kind, but also proceeding with participation of active metals, take place in many reactions of organic synthesis, which can be presented in a general form as 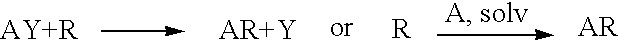
where AY is a compound of an active metal A with Y, R is an organic substance, solv—a special solution of liquid ammonia or tetrahydrofuran type. Typical problems here consist in maximally separating the products of reaction and removing dissolvents, keeping in mind high explosive risk and flammability of reagents.

It is an object of the present invention to provide a method of obtaining protective coatings on the surface of chemically active materials comprising a mixture of a chemically active metal and a fusible stable element which provides useful sources for metal vapors in a more efficient way than heretofore proposed.

It is a further object of the present invention to provide chemically active materials, especially suitable as sources for metal vapors, which overcome the disadvantages of the state of the art as mentioned above.

In one aspect of the invention, a method of obtaining protective coatings on the surface of chemically active materials comprising a mixture of a chemically active metal and a fusible stable element is provided which is characterized by comprising the steps of
providing at least one chemically active metal A
providing at least one fusible stable element B
mixing metal A and element B to form a mixture
treating said mixture at its surface with a liquid agent L, which is capable of dissolving metal A but not capable of dissolving element B, at a temperature which is higher than the melting point of element B thereby creating a coating consisting essentially of element B at the surface of said mixture
ceasing treatment when the desired thickness of the coating has been achieved
removing the liquid agent and
cleaning and drying the mixture.

The essence of the method according to the invention lies in the treatment of the surface of the mixture of chemically active metal A and fusible stable element B with a liquid agent L, which dissolves the chemically active metal A but does not react with the other components of the material.

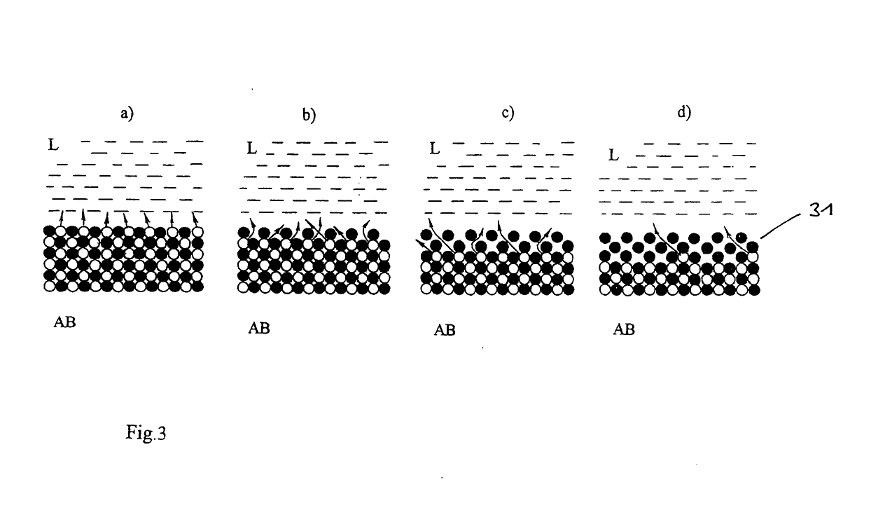

As a consequence of this, metal A is extracted from the mixture, thereby creating an excess of stable element B on the surface of the material. In the course of the treatment this excess forms into a continuous liquid film (cf. FIG. 3). The film isolates the material from the further direct contact with liquid agent L. After ceasing the treatment a stable film or coating consisting essentially of element B is achieved on the surface of the material, which protects the material, and especially active metal A from atmospheric or other influences.

Whilst in the prior art of methods of obtaining protective coatings the coating material always comes from outside, in the method according to the invention the formation of the protective coating takes place due to the inner material resource of the object under treatment.

For the method according to the invention, it is important that the temperature of the treatment is higher than the melting point (T_{f}) of element B. If the process is carried out at a temperature being lower than the melting point of element B, then the interlayer of atoms of B, which is formed by the treatment, remains permeable for molecules of the liquid L and, therefore, erosion of the mixture AB continues within the material until complete decomposition.

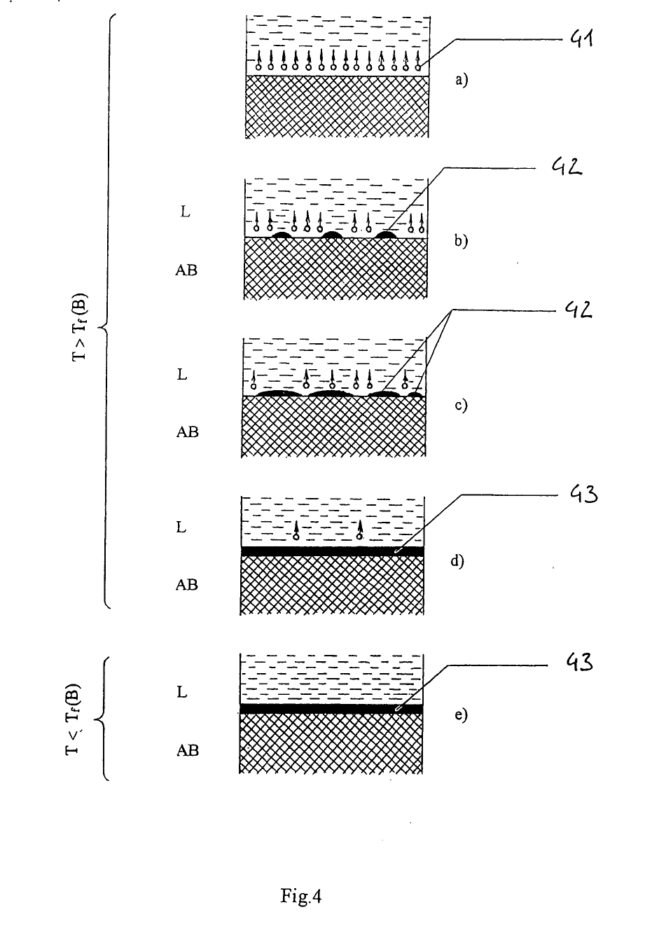

However, if the temperature of the process is T>T_{f}(B), then the interlayer B becomes dense due to the structural transition, which is taking place in it. At the beginning, nucleuses of B melt appear in the bulk of the interlayer, then these nucleuses develop into islands, islands of B melt grow, new ones appear, etc. (cf. FIG. 4) till all of them at last merge into a continuous liquid film of the component B. From this moment the process of extraction of metal A transfers to the diffusion range and the growth of the film B becomes controllable.

The method of the invention for the first time makes it possible to create protective coatings on intermetallic compounds containing the most electropositive metals.

Therefore, metal A may be selected from the group consisting of alkali, alkali-earth, rare-earth metals and actinoids. Especially, metal A may be selected from the group consisting of lithium, sodium, potassium, rubidium, cesium, magnesium, calcium, strontium, barium, radium, lanthanum, praseodymium, erbium, europium, ytterbium, uranium, plutonium and thallium.

Element B may be selected from the group consisting of the elements in group III, IV, V and/or VI of the Periodic System and their binary and ternary combinations with each other. Especially, element B may be selected from the group consisting of gallium, indium and/or tin and their binary and ternary combinations with each other.

The composition of the protective shell is chosen in accordance with the destination of the material. Due to the fact that the activation temperature of the material is determined by the melting temperature of the B—coating, then in order to obtain a wide range of activation temperatures for many applications, different elements B or their combinations with each other may be used. Thus, for applications in organic synthesis Ga—coatings with melting temperature about 30° C. are convenient, Sn—coatings can be recommended for vacuum applications, e.g., in the creation of alkali metals sources, Pb—coatings are best suitable for working in acid media, etc. Some examples of metallic materials with the fixed temperature of the transition of solid to liquid are given in table 1 below.

TABLE 1
Potential protective coatings.

| | | | | | | | | | | | | |
|---|---|---|---|---|---|---|---|---|---|---|---|---|
| Shell | Ga- | Ga- | Ga | In- | In- | Sn- | In | Sn- | Se | Sn | Bi | Pb |
| Material, | 14% In | 8.4% Sn | | 21.5% Bi | 50% Sn | 43% Bi | | 26% Pb | | | | |
| At % | | | | | | | | | | | | |
| Melting | 15.3 | 20.5 | 29.8 | 72.7 | 120 | 139 | 156 | 183 | 221 | 232 | 271.3 | 327.5 |
| temperature, | | | | | | | | | | | | |
| ° C. | | | | | | | | | | | | |

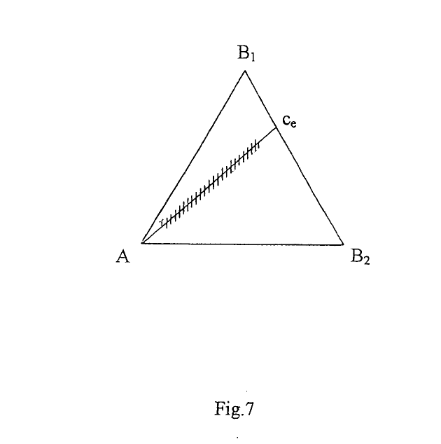

In the cases, when a binary alloy is the most suitable material for building a protective shell, e.g. having an eutectic composition ce (cf. FIG. 7), a ternary mixture of composition A-B₁-B₂ should be synthesized for making granules having a concentration according to the line A-cₑ, i.e. having the same ratio between the components B_{1 and B}₂ as in cₑ.

The liquid agent L may be selected from the group consisting of (a) substances the boiling point of which is higher and the melting point of which is lower than the melting point of element B, (b) mixtures of substances according to (a) and (c) solutions of substances according to (a) or their mixtures (b) in solvents which are neutral to both metal A and element B., i.e. liquid agent L should satisfy a requirement
m.p. (L)<T_{f}(B)<b.p. (L),
where m.p. (L) is a melting point of a substance L, and b.p. (L) is its boiling point.

Liquid agent L may preferably be selected from the group consisting of CH-acids, aliphatic alcohols, polyhydric alcohols, higher carboxylic acids, condensed arenes and/or macrocyclic polyethers, their mixtures and solutions thereof.

These substances may be divided into two groups, depending on whether gaseous hydrogen is produced during the process of film growth or not.

The first group is made up from some classes of organic compounds, reacting with A according to a substitution reaction
RH (l)+AB(s)→RA(l)+B(l)+½H₂ (g),
where l, s, and g are indexes indicating liquid, solid, and gaseous state, respectively.

Excluding toxic substances, these substances are e.g. some high-boiling alkenes R—H (triphenylmethane, etc.), high-boiling ethers R—O—R′ and esters (diethyleneglycole, malonic ester, etc.), higher aldehydes R—CHO and ketones R—CO—R′ (toluic aldehyde, 2-heptanone, etc.), higher aliphatic and polyhydric alcohols R—OH (cetyl alcohol, propylene glycol, ethylene glycol, glycerol, sorbitol, xylitol, etc.), higher carboxylic acids R—COOH (stearic acid, palmitic acid, oleic acid, etc.) and other substances, their mixtures and solutions thereof in liquid dilutants D, which are inert towards AB.

Liquid ammonia, tetrahydrofuran and other ethers (anisole, diphenyl ether, etc.), aromatic hydrocarbons (benzol, xylene, etc.), paraffins (heptane, hexane, paraffin, etc.) belong for example to this kind of dilutants.

The second group of extractants L reacting with metal A according to addition reaction
L+AB (s)→AL (l)+B (l)
comprises condensed arenes (naphthalene, anthracene, etc.), macrocyclic polyethers ([18]-crown [6], etc.) and others, their mixtures solutions thereof in dilutants D as mentioned above.

Preferably ceasing treatment with the liquid agent L is accomplished by decreasing the temperature below the melting point of element B.

The thickness of the coating may be 1 μm or more, preferably 10 μm or more.

The thickness of the coating may be controlled by the adjustment of the duration and/or the temperature of the treatment with liquid agent L.

There are four possible ways to influence the dissolution speed of metal A and accordingly the thickness of the coating B: Changing the temperature of the process, changing the time of treatment, changing the liquid L and changing the hydrodynamic situation near the surface of the mixture of A and B.

The temperature and the extraction time allow fine control over the thickness of the growing coating: The higher the temperature and the longer the treatment, the thicker is the B—coating.

Changing from one liquid L to another liquid or diluting liquid L with a neutral dilutant D, which does not react with the components of the material AB, also influences the kinetics of formation and growth of the film B.

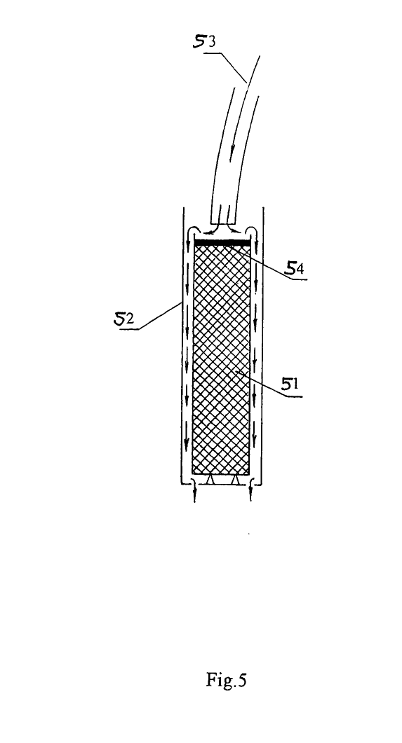

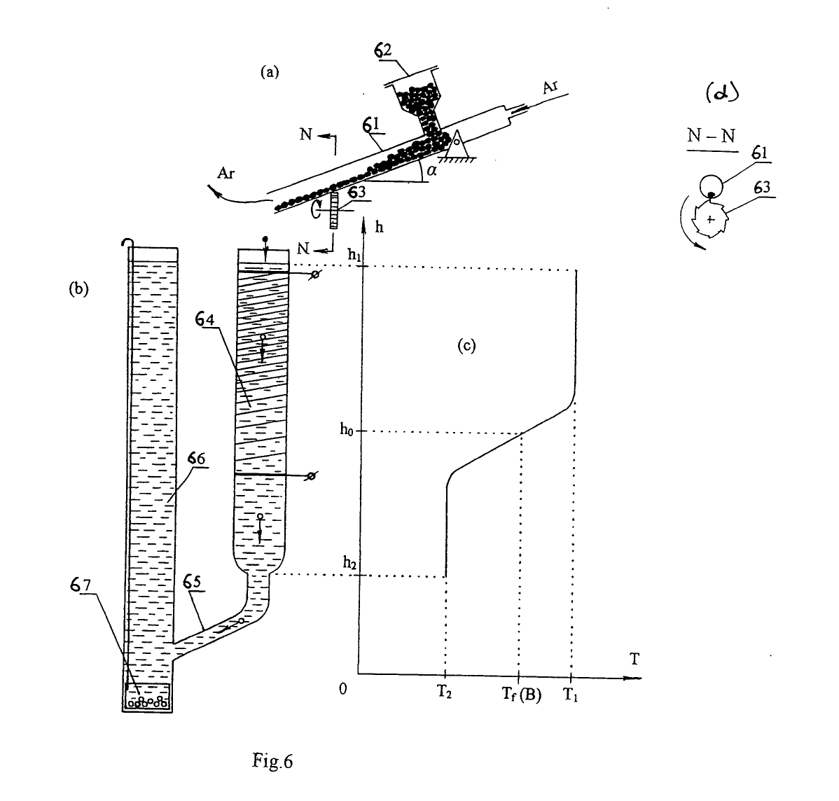

To improve the uniformity of the coating, convection in liquid L is used. In the case of large surfaces of mixture AB streams of liquid L flowing around this surface are created (cf. FIG. 5). In the case of small particles of AB these particles are moved, e.g., under the influence of gravitational forces, in the non-moving medium L (cf. FIG. 6).

When the target thickness of the coating is achieved, the process is stopped. For this it is enough to decrease the temperature of the system AB-L to the value T<T_{f}(B). Then the liquid film B solidifies and the diffusion transfer of A atoms through the solid continuous B layer becomes impossible.

Preferably the mixture of metal A and element B is immersed in liquid agent L.

The mixture of metal A and element B may be formed into a desired shape before treatment with liquid agent L. It is, however, to be understood that the shape of the mixture of metal A and element B may also additionally slightly change during the treatment with liquid L.

Preferably, the mixture of metal A and element B is formed in essentially spherical shape before treatment with liquid agent L. In this case, preferably the essentially spherically formed mixture is dropped into a bath of liquid agent L.

Furthermore, the mixture of metal A and element B may be formed in cylindrical form or in form of a plate before treatment with the liquid agent L.

The process of encapsulation of small particles of AB with an average linear size from −1.0 to ˜5.0 mm may preferably be carried out in two variants:
dropping the melt of AB into liquid L or
throwing solid particles of AB of arbitrary shape or in the form of cast shot into liquid L, the upper layers of which are heated up to the temperature T>T_{f}(B).

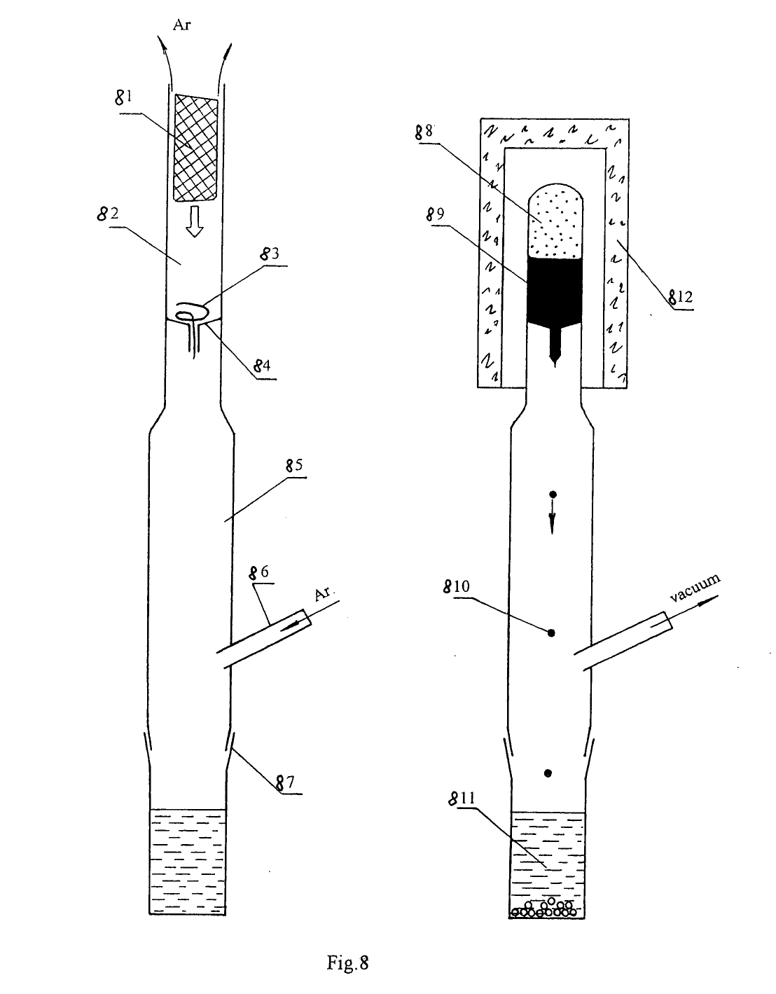

In the first case the melt AB is pressed through a capillary opening into a flight tube with a particle collector, filled with liquid L (cf. FIG. 8). The droplets solidify in liquid L and then they are covered with a coating B during the movement downwards. A big storage of thermal energy contained in the melt droplets of AB makes heating of the upper part of the bath to the temperature T>T_{f}(B) unnecessary. However, the lower layers of the liquid bath L should be maintained in the temperature level T<T_{f}(B).

In the second case the solid particles of AB are thrown down into a vertically extended bath with liquid L (cf. FIG. 6), the upper zone of which is heated to T>T_{f}(B), and the lower one has a temperature T<T_{f}(B). The particles get covered with liquid shell B during sinking in the hot layers, then this shell solidifies in the lower cold layers of L. The thickness of the coating is controlled with the help of two parameters, the length of the hot zone Δh=h₁−h₀ and the temperature of this zone T₁. While setting the treatment regimes the moment of formation liquid film B is fixed visually when shining metallic surface appears on the particles.

The first test for the quality of the coating is exposure of encapsulated granules in water at a temperature T<T_{f}(B). The absence of gassing during this exposure indicates continuity of the coating.

After the surface passivation the product (big ingots or small lump) is thoroughly washed in suitable solvents for removing agent L, dried and then used according to the respective purpose.

Further main features and merits of the method of the invention are:
High capacity: The typical time for forming the protective coating is a few seconds.
Universality: The process of the film formation does not depend on the surface size or shape. The method can be applied to a wide range of products, which differ in the nature of active component, the number of such components, and their concentration. In particular, this method for the first time made it possible to create protective coatings on materials containing alkali and alkali-earth metals.
Simplicity of technology: The process does not need complicated equipment, takes place at low temperature and can be carried out using cheap and available reagent.
Controllability of the process: A full control of the process of the film growth is possible with only two parameters—treatment time and temperature of liquid agent L.
Indifference to the state of the initial surface: As the upper layer of the material is partially removed during the treatment with liquid agent L, and partially restructured, it is not necessary to prepare the surface preliminarily. This is very important considering the chemical activity of the material.

In a further aspect the present invention provides a chemically active material with a protective coating on its surface which is obtainable by the method of the invention as described above.

The new materials according to the invention represent intermetallic compounds the free surface of which is covered with a film of stable element B. Its main advantage is that it can be handled, stored and transported in the same way as any other usual substance. It is, for example, not necessary to store the materials according to the invention under vacuum or protective gas.

If the material according to the invention is heated up, vapors of chemically active metal A are set free in a very controlled manner. The evaporation temperature depends on the material composition. For example, in the case of materials comprising Na, K and/or Cs as metal A, the evaporation temperature may be in a range from 400° C. to 700° C.

Encapsulated intermetallic precursors and their advantages have been described in Vacuum 47, 79-82, 1996 Vacuum 47, 463-466, 1996; Vacuum 55, 101-107, 1999; and in a poster “Intermetallic precursors” of K. A. Chuntonov and T. B. Stenitzer at the second International Conference Inorganic Materials, Santa Barbara, USA, September 2000), however, in neither of these publications the method of manufacture of these intermetallic precursors has been disclosed.

The material according to the invention combines both approaches of the prior art to solve the problem of active materials protection, namely, using a shell and using a mixture of components, which allows to eliminate the disadvantages of each of them and to use their strong aspects.

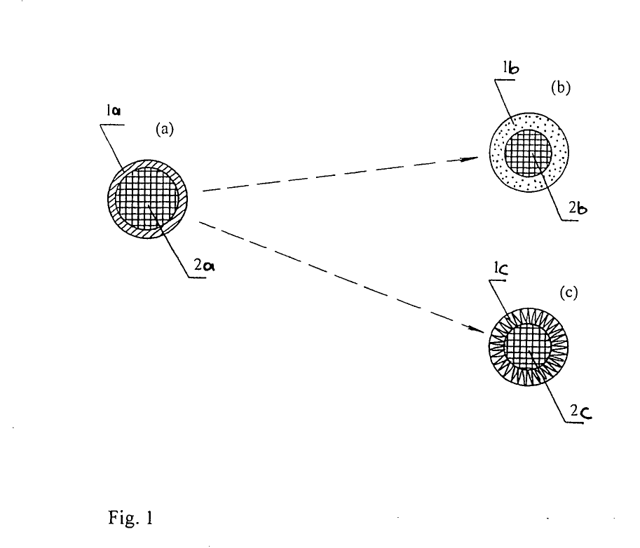

A structure of an encapsulated granule according to the invention is shown in FIG. 1: A chemically active intermetallic core AₙBₘ (in the following referred to as “AB”), where A is an active metal, is enclosed in a shell of a fusible stable element B. Under usual conditions, the solid overlayer B is impermeable for water, air, and any other substances towards which the element B is chemically stable. These granules permit performing any operations with them, which are allowed for working with element B, and do not need any safety precautions.

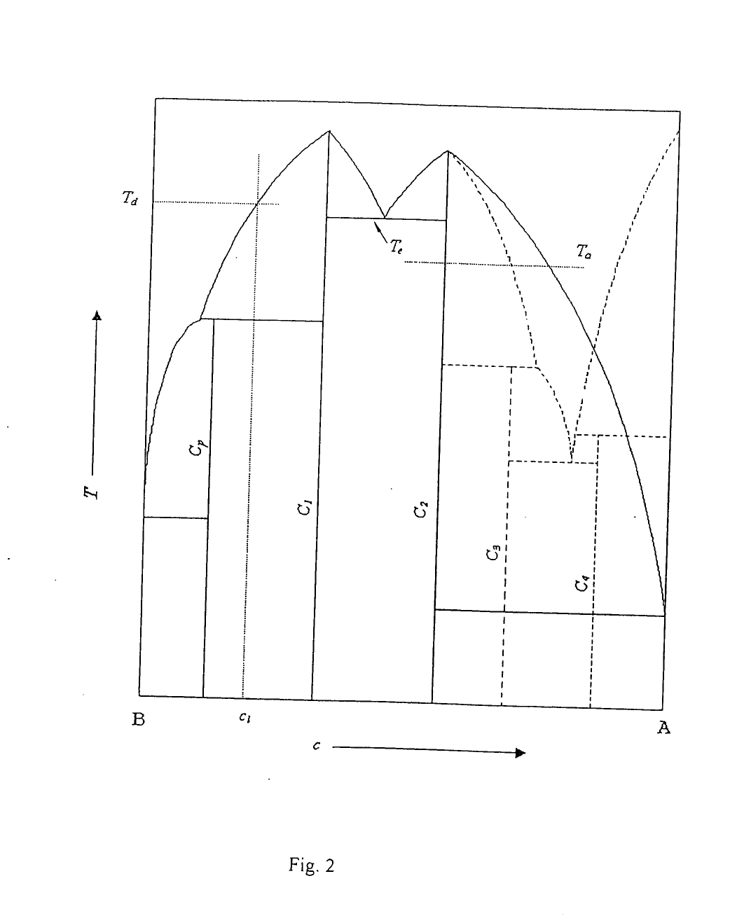

When temperature is increased to T>T_{f}(B), where T_{f}(B) is a melting point of element B, the granule is activated. If the granule core corresponds to composition c≦C₁ (cf. FIG. 2), then the shell turns into semi-permeable membrane having composition cₗ, letting atoms of A pass to the granule surface. In this case a granule is a controllable source of metal A (FIG. 1b), and can be used either as an Alkali Metal Dispenser or as an evaporable getter, or as a pure supplier of atoms A for different reagents R, etc.

If the core has a composition C₁<c≦C₄ (cf. FIG. 2), then at T>T_{f}(B) the shell B reacts with the core according to
Cₙ+B→Cₙ₋₁+Cₙ₋₂+ . . . ,
where n=2, 3 or 4. As a result the protective film disappears and an extremely active disperse layer, which opens an access to the main active core Cₙ, appears on the granule surface. This kind of material is an excellent chemisorbent and can be used as a non-evaporable getter in vacuum sealed off devices or in filters for gas purification.

In a further aspect of the invention there is provided the use of the chemically active material according to the invention as a vapor source, as a chemisorbent, as a source of active metals in chemical synthesis in the form of a catalyzer or in the form of a constituent of the produced product and/or for the manufacture of special alloys, sublimation pumps and/or particle accelerators.

Preferably the chemically active material is used as a vapor source in the production of photoemissive devices (such as photocells, photomultipliers, vidicons, image converters) and in organic light emission diodes production, and the like.

The chemically active material may also be used as a chemisorbent (such as evaporable and non-evaporable getters) in the production of vacuum sealed off devices, e.g. as solar cells, electron tubes like CRT's, X-ray tubes, lamps, Dewar vessels, vacuum isolation panels and pipes, field emission displays, and the like.

The chemically active material may, furthermore, be used as a chemisorbent for gas purification, e.g. for evaporable and non-evaporable getters in plasma displays, gas filters, and the like.

The chemically active material may also be used in other applications, for example as a special alloy (using elements like Eu, Yb, Na, Li and the like), in sublimation pumps, in particle accelerators, and in many more possible applications.

The present invention will now be illustrated with reference to the figures and the following examples of preferred embodiments, which shall not be construed as being limiting the scope of the invention:

FIG. 1:

The structure of an encapsulated granule according to the invention is shown, wherein
(a): shows a granule at T<T_{f}(B) wherein 1a denotes a solid shell B, and 2a denotes an intermetallic core;
(b): shows one embodiment of a granule at T>T_{f}(B), wherein 1b denotes a liquid shell with the composition cₗ(cf. FIG. 2), and 2b denotes a core having a composition c=C₁;
(c): shows a further embodiment of a granule at T>T_{f}(B), wherein 1c denotes a dispersed layer of a composition C₁+C₂+ . . . , and 2c denotes a core with the composition C₁<c≧C₄.

Two cases of a granule's behavior at heating depending on the core composition are shown. If a core has a composition c≦C₁ (FIG. 2), then at T>T_{f}(B) the core partially melts with the formation of a liquid shell of a composition cₗ (FIG. 2) and serves as a semi-permeable membrane for metal A, allowing atoms of A to pass from the core AB to the outer surface of the shell cₗ. From the surface of the shell cₗ atoms A can evaporate, like in vapor sources of alkali metals or in evaporable getters, or enter into a corresponding liquid medium, which consumes active metal A, as it happens in organic synthesis reactions. If the core has a composition C₁<c≦C₄ (FIG. 2), then when the granule is heated to T>T_{f}(B) the shell B reacts with the core creating on the surface a spongy disperse layer C₁+C₂+ . . . , which (as the experience shows) surpasses pure metal A in chemical activity. This material is an excellent chemisorbent for vacuum applications in sealed-off devices and for pure gases production, e.g. in corresponding filters. It has a low activation temperature Tₐ≅T_{f}(B) and works at room temperatures, surpassing in this respect the standard non-evaporable getters (NEGs).

FIG. 2:

FIG. 2 shows a generalized phase diagram of the system A-B, wherein A—an active metal and B—a fusible stable component; Cₚ, C₁, C₂, . . . —intermetallic compounds; cₗ—a composition of a liquid phase, which is in equilibrium with crystals C₁ at temperature T_{d}; and in the concentration range C₂-A:
[symbol] means phase boundaries in case A is an alkali metal;
- - - means phase boundaries in case A is an alkali—earth metal.

FIG. 2 illustrates by way of an exemplary binary system, how the selection of a material for granules for different applications is carried out. In order to be suitable as a controlled generator of vapor of A, including also evaporable getters, or as a controlled source of metal A in chemical reactions, an active granule core should have a composition c=C₁. In this case at temperatures T_{d}<T_{f}(C₁), where T_{f}(C₁) is a melting temperature of a compound C₁, transport of the metal A through the liquid shell cₗ takes place in a quasi-stationary regime, i.e. with a constant rate. For a use as a non-evaporable getter intermetallic compounds with higher concentration of an active metal, e.g., C₂, C₃, . . . etc. should be used as a material for a core. These compounds form a thermodynamically unstable pair with the shell B, which at heating to T>T_{f}(B) undergoes a reaction followed by disintegration of the protective shell.

FIG. 3:

FIG. 3 illustrates the initial stage of treatment with liquid agent L, wherein AB—the intermetallic mixture of metal A and element B, L—liquid agent L, ◯—atom A, •—atom B, 31—interlayer of B

FIG. 3 shows a mechanism of initiation of an interlayer B 31 on the boundary between solid AB and liquid L. A spongy structure of the interlayer B does not prevent erosion of the material at temperatures T<T_{f}(B), but increasing the temperature to T>T_{f}(B) creates conditions for structural changes, leading to the appearance of a continuous liquid shell B.

FIG. 4:

FIG. 4 illustrates the main stages of the film formation process:
(a) shows an initial stage (corresponds to the status in FIG. 3), atoms 41 of metal A dissolving into liquid agent L;
(b): appearance of islands 42 of B melt in a spongy interlayer;
(c): a developed phase 42 of island structure;
(d): a continuous film 43 of melt B and a change to a diffusion regime of extraction;
(e): decreasing of temperature and formation of a solid protective coating 43 of B.

Different stages in the process of a protective coating formation are presented from nucleation islands 42 of melt B (b), their growth (c) and merging of these islands 42 into a continuous liquid film 43 of component B (d) up to its solidification (e) at decreasing the temperature to T<T_{f}(B). The most important moment in the whole process corresponds to the state (d), after which the temperature of the system AB-L can be decreased for stopping the extraction of the A—metal, or can be maintained for further growing of the coating thickness. Earlier cooling of the system, e.g., from the state (c), would be premature and cause surface defects, namely, the presence of open (unprotected) areas in the shell.

FIG. 5:

FIG. 5 shows an example of the passivation of ingots, wherein 51 denotes a container comprising an ingot of a mixture of AB, 52 denotes a glass test tube, 53 denotes a flow of liquid L and 54 denotes the coating of element B formed by this process.

It is shown, how the treatment of a plane surface of an ingot AB with liquid L for obtaining protective coating B is carried out. A cylindrical container 51 with an ingot of mixture AB is inserted into a glass test tube 52 having an opening in the lower part for exit of the liquid L. Liquid agent L 53, heated up to T>T_{f}(B), is fed from above to the open surface of the ingot, washes this surface and flows down along the outside container wall taking away products of solution.

When a shining pure film 54 appears on the ingot surface, the temperature of the extractant 53 is decreased to T<T_{f}(B) and its feeding is stopped. The ingot surface and the whole of the container are thoroughly washed with a neutral dissolvent, which removes the residuals of liquid L. Then the container is placed into a reservoir with distilled water for testing continuity of the coating and, finally, water is washed away with acetone or alcohol. For drying the product blowing with air and vacuum are used.

FIG. 6:

FIG. 6 shows a technique for granule encapsulation, wherein
(a) shows a dosing apparatus comprising a tube 61, a bunker 62 and a ratchet gear 63;
(b) shows an apparatus for passivation comprising a bath 64 with agent L, a bridge 65, a cylinder 66 and ladle 67; and
(c) demonstrates the temperature profile of the bath;
(d) is a view of bunker 62 and ratchet gear 63 according to line N-N in (a)

FIG. 6 presents one of the methods of realization of the process of solid AB particles (lump or shot) encapsulation. The main parts of the apparatus are: a dosing apparatus (a), the task of which is to provide that separate particles of AB roll down one by one to avoid their sticking together in the bath 64 after the liquid shell B appears; a bath 64 with the agent L, where formation of the liquid shell and its solidification takes place; a discharge cylinder 66, which allows to remove a final product as soon as it is collected without interrupting the process.

A charging bunker 62 is used for the same purpose.

Charging of the bunker 62 and throwing AB particles down from a tube 61 is performed in an atmosphere of flowing Ar. The particles enter the bath 64 one by one due to adjustment of a suitable angle of slope a and rotational frequency of ratchet gear 63. The granules are covered in a hot zone (h₁-h₂), the shells solidify in a cold zone (h₀-h₂) and then the encapsulated granules along a bridge 65 get into a cylinder 66, where they are periodically removed with the help of a ladle 67.

Visual examination of the state of the particle surface during their movement through the hot zone and also testing the obtained product for continuity of the coating allow to set a minimal length of the hot zone, which in the given conditions corresponds to the change of the process to diffusion, i.e., controlled range.

The given method imposes less strict requirements to volatility of liquid L, than a method of encapsulation of granules starting from a melt does.

FIG. 7:

FIG. 7 shows a concentration triangle for a system A-B₁-B₂, wherein A is an active metal, B₁ and B₂ are fusible elements, cₑ is an eutectic composition in a binary system B₁-B₂; and the shaded area along the line A-cₑ is a preferable area of compositions for the active core of a granule according to the invention.

The range of potential compositions of protective shells can be essentially widened by using binary or ternary eutectics, consisting of stable elements B. This extension does not only concern the melting temperatures of protective shells, but also their chemical properties. The ternary system A-B₁-B₂ in FIG. 7 gives an opportunity to show how the choice of the shell material is connected with the composition of the granule active core. The ratio of components B₁ and B₂ in the latter should preferably be the same as in the used for the shell eutectic ce. This means that the composition of the granule core should lie on the line A-cₑ.

FIG. 8:

FIG. 8 shows an apparatus for the production of encapsulated granules, wherein 81 is an ingot of a mixture AB, 82 is a melting compartment, 83 is a wire, 84 is a glass membrane with a capillary, 85 is a flight tube, 86 is an exhaust tube, 87 is a ground conic joint, 88 means vapors of volatile metal A, 89 is the melt of mixture AB, 810 is a droplet of the melt of mixture AB, 811 is a bath with liquid L, 812 is a furnace.

The apparatus for obtaining encapsulated granules directly from the melt as shown in FIG. 8 consists of three parts: a melting compartment 82, a flight tube 85 with an exhaust tube 86 and a glass bath 811 connected with the flight tube 85 with the help of a conic ground joint 87. The bath 811 is filled with a liquid agent L, which has a very low vapor pressure at room temperature. The melting compartment 82 is divided into two parts with the help of a glass membrane 84, in the center of which there is a capillary with a metallic wire 83 arranged in it.

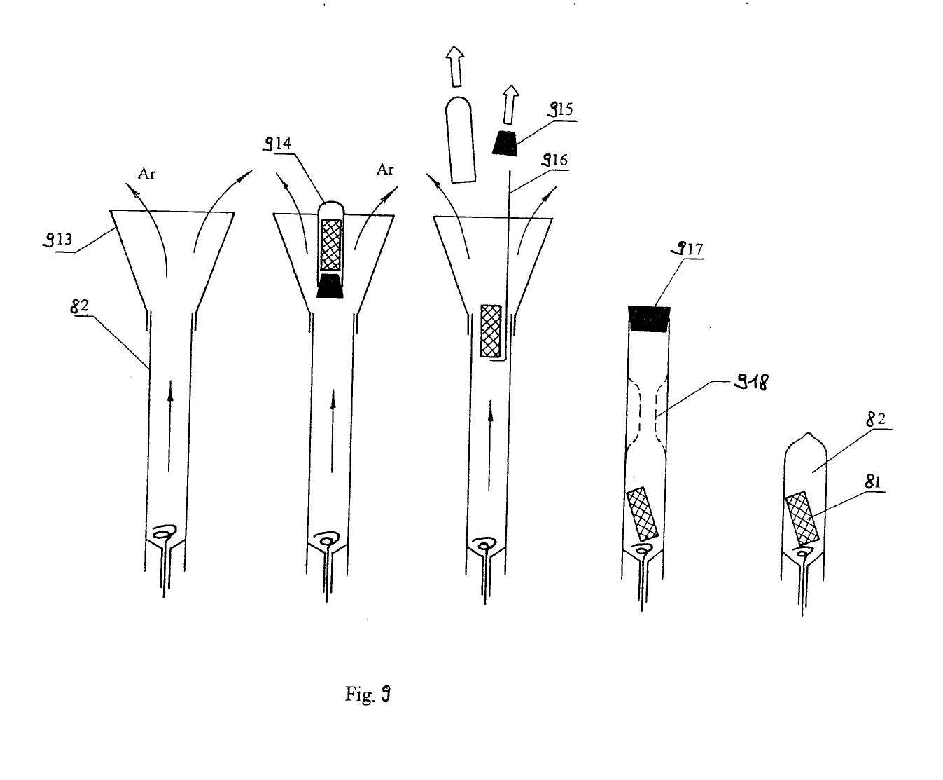

The sequence of operations in this apparatus is as follows. An ingot 81 is introduced into the melting compartment 82 in a counterflow of Argon, stemming from an exhaust tube 86. Then an upper charging part of the compartment 82 is sealed, as is shown in detail in FIG. 9. From above, a furnace 812 is moved onto the melting compartment 82 and the charge starts to be melted at continuous pumping. The ingot melts and the melt is slowly pressed out through the capillary opening due to the forces of its own hydrostatic pressure and vapor pressure of the metal A.

As far as the melt flows the temperature of the furnace is slowly increased to maintain a constant dropping frequency.

The droplets flow down one by one along the wire 83, protruding from the capillary tube 84, detach from it and get into the bath 811 with liquid L, where they are encapsulated. When dropping is over the apparatus is filled with argon, the bath 811 is detached from the flight tube 85 and washing of the product is started.

The melting compartment 82 is cut off somewhat above the flight tube, and a new melting compartment is welded on the vacant place, in this way restoring the apparatus for the next cycle.

FIG. 9:

FIG. 9 shows the operation of charging the ingots, wherein 913 is a cone, 914 is a test tube, 915 is a plug, 916 is a hook, 917 is a lid, and 918 is a neck 81 and 82 denote the ingot and the melt compartment, respectively, as in FIG. 8.

Charging the ingots into the encapsulating apparatus is carried out the following way. In a box under argon the ingot is put into a test tube 914, the test tube is closed with a plug 915 and in this way is then taken out of the box. A big cone 913 is fixed to the upper part of a melting compartment 82 (see also FIG. 8) and from below argon is introduced along the tube 82. A test tube 914 with an ingot 81 is put into the cone 913, the plug is opened and the ingot 81 is released.

The ingot 81 is moved down deep into the tube of the melting compartment 82 with the help of a hook 916, and the test tube 914, the plug 915 and the cone 913 are taken away. Without interruption of the argon flow with the help of heating a neck 918 is created on the tube, the tube is hermetically closed from above with a lid 917 and after argon is pumped away the upper part of the tube is sealed across the neck. The apparatus is ready for dropping and encapsulation of granules.

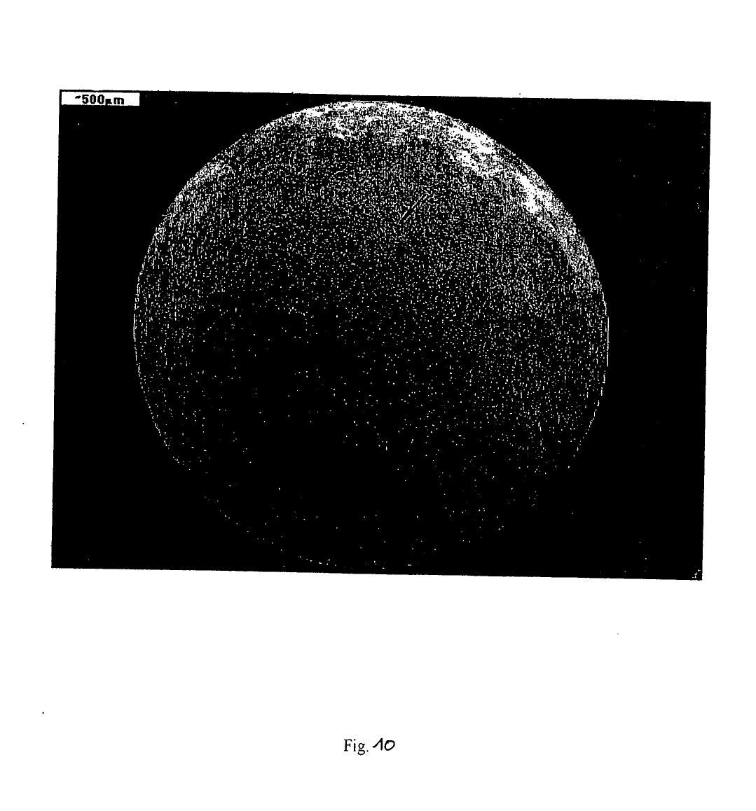

FIGS. 10 to 19 will be discussed below with regard to Example 7.

### EXAMPLES

### Example 1

A thin-walled Ni-cartridge with an ingot of Na₈In₁₁ is mounted under a heptane layer into a Pyrex test-tube, as shown in FIG. 5. Diethyleneglycol is fed from above onto the ingot surface and its temperature is increased to 180° C. As soon as a shining liquid layer of In appears on the ingot surface, the temperature of diethyleneglycol is decreased to 100° C. and after it is made sure that the In-coating has solidified, feeding with diethyleneglycol is stopped and the cartridge with the ingot is started to be washed with warm water and acetone.

The whole procedure of passivating the surface takes several minutes. The obtained ingot with In-coating can be used as a massive Na vapor source in a MBE chamber or in sublimation getter pumps instead of Ti.

### Example 2

A cylindrical ingot of In-20 at % K, 14 mm in diameter and 40 mm high, is introduced (as described in regard to FIGS. 8 and 9 into a Pyrex apparatus for dropping the melt. A capillary tube in the center of a membrane 84 (FIG. 8) has an inner diameter of ˜1 mm and a length of ˜10 mm. Inside a capillary there is a Nichrome-wire of 0.8 mm in diameter, which extends throughout the capillary and protrudes out of the capillary for ˜3.0 mm from the lower end of the capillary. After evacuation of the apparatus the charge is melted and in a regime of slowly rising temperature the melt starts to flow down with a frequency of droplet forming of 1.0-0.25 s⁻¹.

The droplets get into the bath with glycerol, the upper layer of which is approximately 10 cm high and is preliminarily heated to ˜80-100° C., the lower layer being approximately 15 cm high and having room temperature. Hydrogen, which is released during the encapsulation process, is continuously pumped off.

When the process is completed, the granules are washed free from glycerol with warm water, alcohol, and are dried. Measurement of the In-shell thickness shows that the granules with the average size of ˜3.0 mm have a coating of 80-100 μm thickness.

Granules of In-20 at % K with In-coating can be used as controlled and safe-in-handling-sources of pure potassium in reactions of organic synthesis or as controlled vapor generators of potassium in the production of photoemissive devices.

### Example 3

Granules of Na₂₂Ga₃₉ of diameter 1.2-1.5 mm are thrown from a dosing apparatus down into a bath (FIG. 6) of ethylene glycol. The hot zone of the bath has T₁=120° C. and a length of Δh=250 mm and its cold zone has T₂=10° C. The particles of Na₂₂Ga₃₉ encapsulated with a Ga-shell (made according to the procedure described with regard to FIG. 6) are then washed with distilled water and acetone at a temperature not higher than 20° C. and, finally, are dried under vacuum.

Another portion of granules of the same composition and size is thrown down into a bath with 2-heptanone. The hot zone of the bath has T₁=120° C. and a length of Δh=250 mm and its cold zone has T₂=10° C. The product is washed free from liquid reagent with acetone at 20° C. and dried under vacuum.

To avoid that the particles stick together due to the fusible Ga-coating the product should be stored at a temperature not higher than 20-22° C.

Na₂₂Ga₃₉ granules with a Ga-shell are good sources of Na-vapor for vacuum applications: They can withstand degassing in vacuum up to 400° C., and at heating in the range from 450° to 600° C. they generate Na-vapor with the intensity necessary for manufacturing of photocathodes. Another field of using these granules is the field of chemical reactions in organic synthesis, in which a participation of sodium is needed.

### Example 4

Spherical granules having the composition InLi with an average diameter of 2.88 mm are thrown from a dosing apparatus (FIG. 6), heated to ˜180° C. with the help of flowing argon, into a bath 64 of diethylene glycol at T₁=180° and T₂=25° C.

For the first portion of 20 shots the length of the hot zone is set equal to 220 mm. Encapsulated granules are taken out with the help of a ladle 67 and washed with water and alcohol. The results of chemical and metallographic analysis show that the thickness of In-shell is ˜0.2 mm. The encapsulation procedure is repeated for the second portion of InLi granules consisting of 20 shots at the same temperature parameters, but with the length of a hot zone equal to 340 mm. Measurements of the thickness of In-shell in this case show the value of 0.35 mm. For the third portion of InLi granules consisting of 20 shots the length of the hot zone is increased to 700 mm, which leads to the growth of the In-coating thickness to˜0.45 mm.

InLi granules in an In shell are an excellent working material for Li-evaporable getters and are also a Li-source for organic synthesis reactions.

### Example 5

Pieces of an alloy Sn-40 at % Ba with an average linear size of 1.8-2.5 mm are thrown from a dosing apparatus (FIG. 6) into a bath of glycerol, for which T₁=245° C., T₂=25° C. and the length of the hot zone is 300 mm. The product is washed in warm water and acetone. Chemical analysis shows that the product has a composition Sn-33 at % Ba and this corresponds to a thickness of the Sn-coating equal to ˜120 μm.

Granules of this type are controllable sources of Ba and can be used as Ba-evaporable getters in vacuum sealed devices or as super pure reagents for precise introduction of Ba-cations into organic compounds.

### Example 6

Pieces of the intermetallic compound Cs₂In₃ with an average linear size of 1.8-2.0 mm are treated as described in example 5 by using a bath with a 15% solution of malonic ester in diphenyl ether at T₁=170° C., T₂=30° C. and the length of the hot zone being 400 mm. The obtained product is washed free from liquid reagent first with isopropanol, then with distilled water and is dried under vacuum.

Granules of Cs₂In₃ with an In coating can be further used as controlled sources of Cs vapor in photocathode production, organic light emission diodes or as a safe reagent in organic synthesis of Cs-containing substances.

### Example 7

To demonstrate the film formation mechanism during the treatment of the initial solid particles of AB with liquid L, the results of electron microscope analysis of granules Na₈In₁₁ are shown in FIGS. 10-19. The mentioned granules having a diameter from 2.5 to 3.0 mm were exposed for different periods of time in a bath with a 30% solution of stearic acid in paraffin at 165° C. After exposure for τ seconds the granules were taken out of the bath, washed several times in hot heptane and then analyzed. The received data are listed below in Table 2.

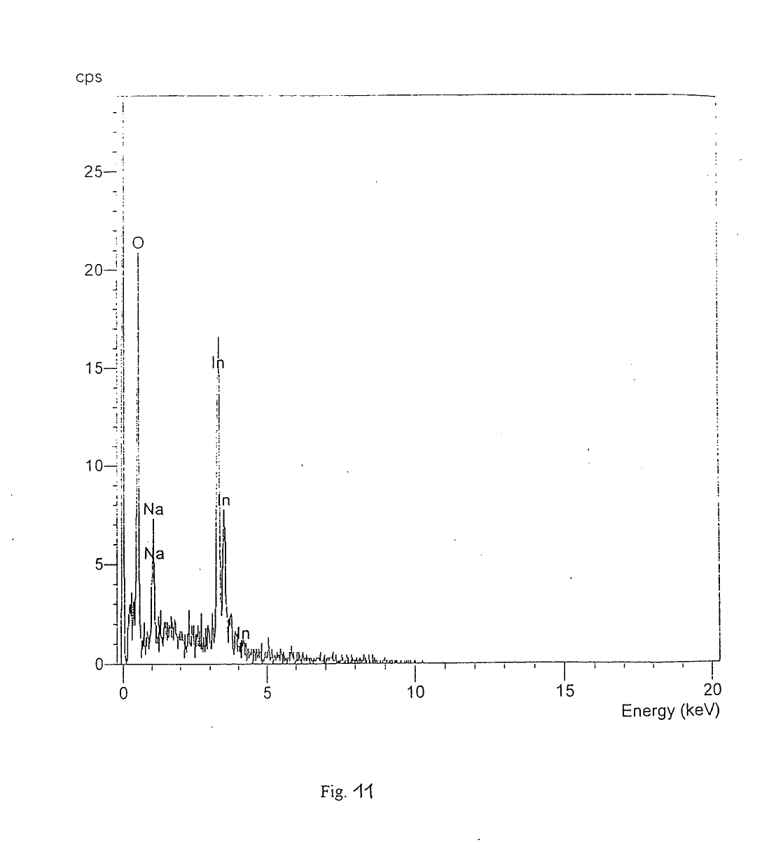

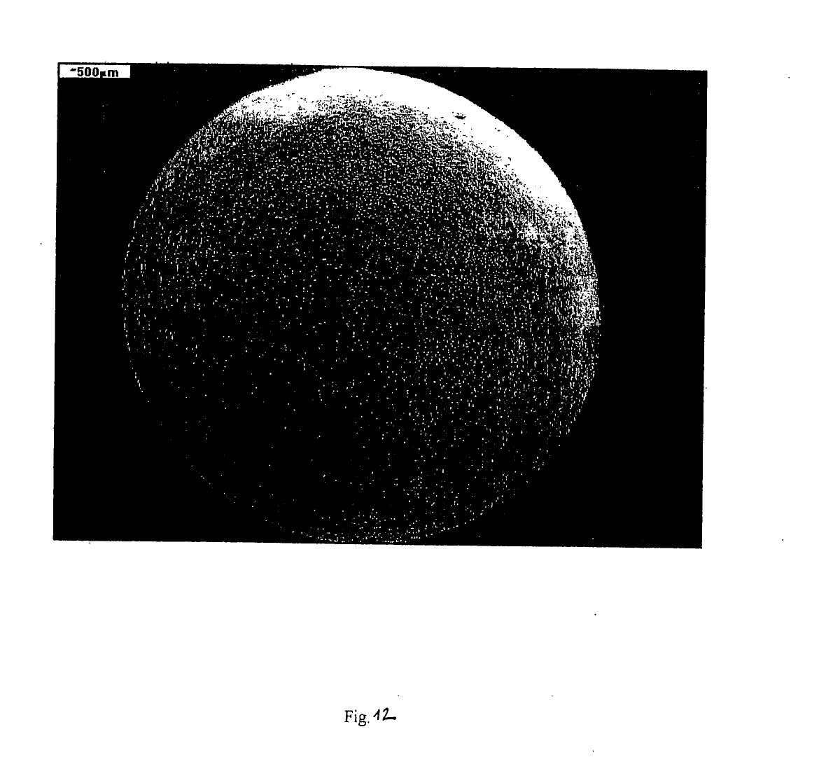

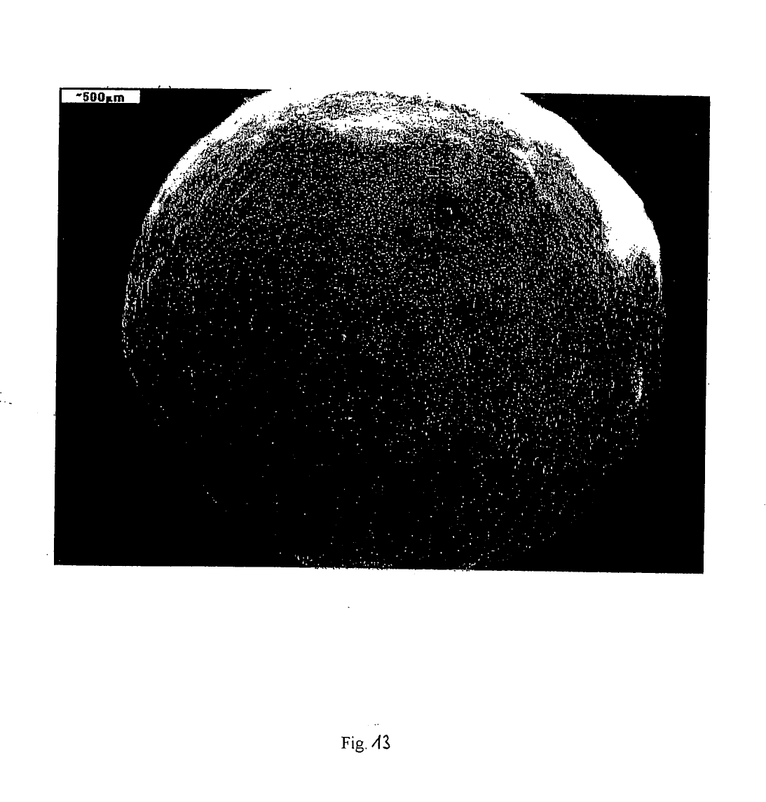

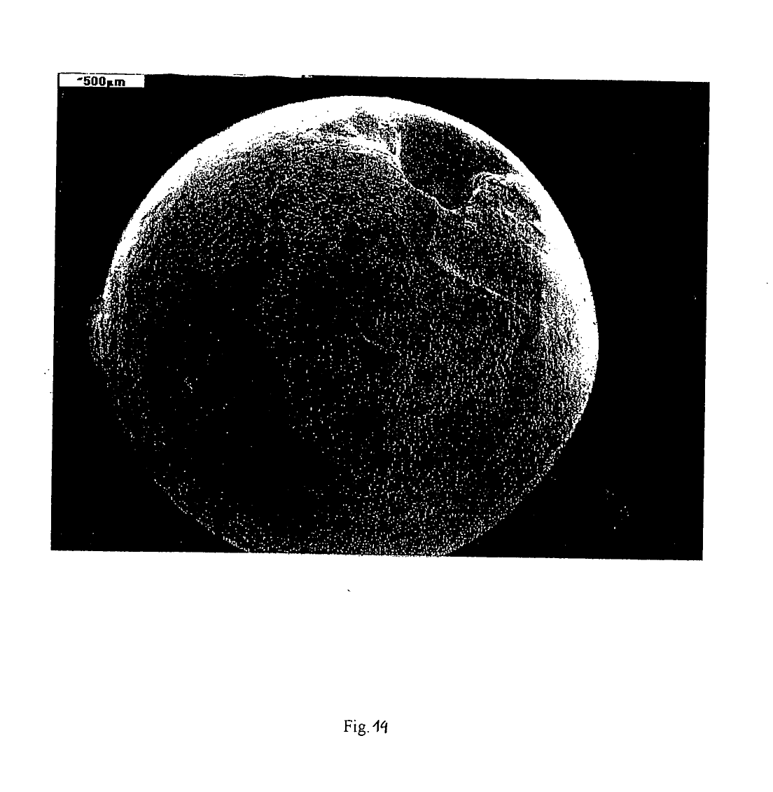

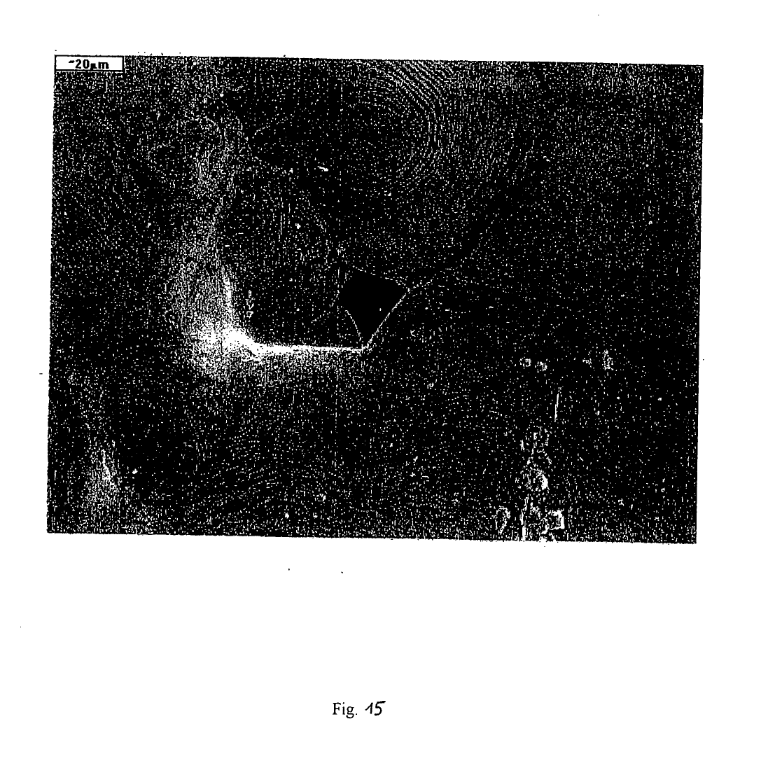

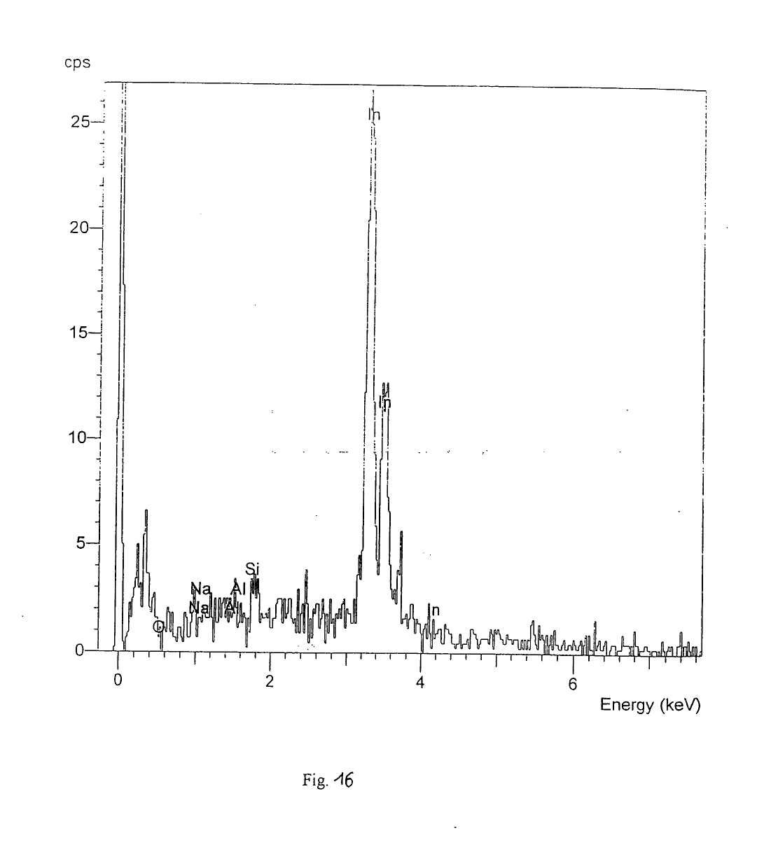

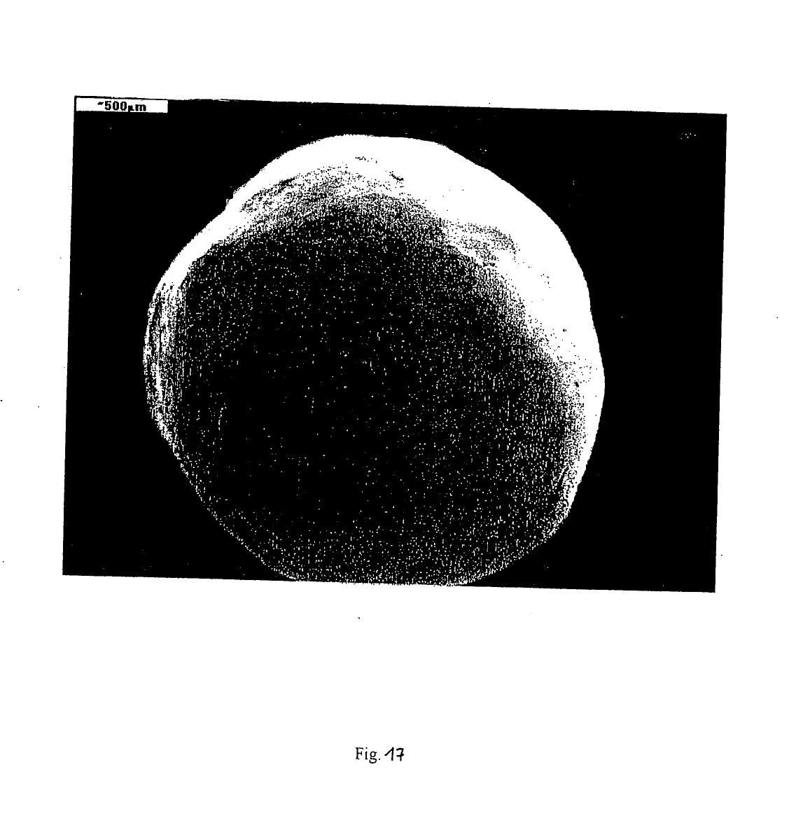

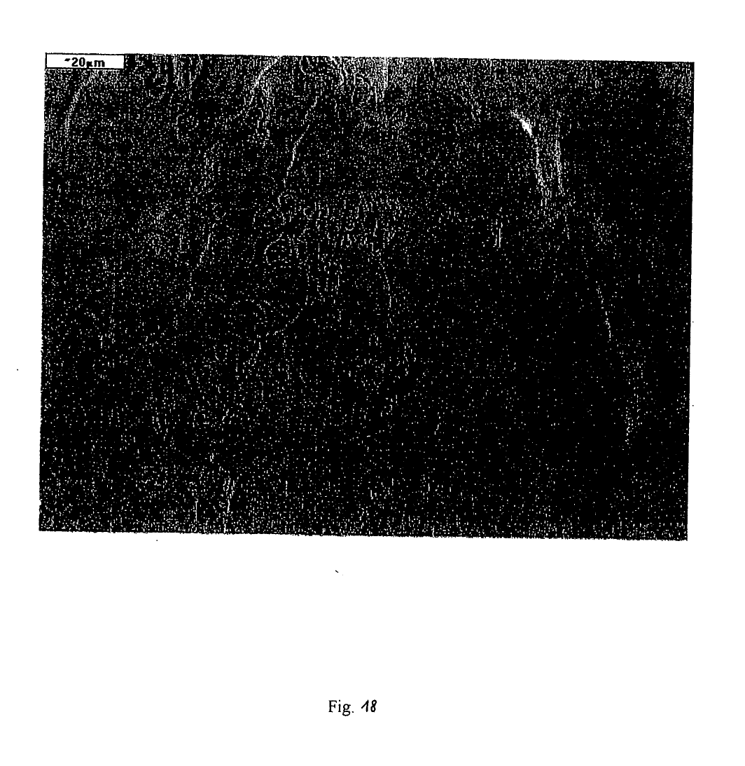

TABLE 2
Morphological changes in the process of granule encapsulation.

| | Time of | | |
|---|---|---|---|
| | exposure in | | |
| Test | extractant | | |
| No | τ (s) | Surface state | Reference |
| 1 | 0 | Homogeneous | FIG. 10: General view of a granule before |
| | | surface of the | treatment |
| | | compound | FIG. 11: Elemental analysis of the marked |
| | | | region shows that the composition of the |
| | | | surface is close to the bulk composition. |
| 2 | 1 | Appearance of | FIG. 12: Light spots on the surface |
| | | separate islands of | |
| | | In | |
| 3 | 3 | A developed system | FIG. 13: Evident increase of the number and |
| | | of In islands | size of light spots on the surface. |
| 4 | 5 | Practically | FIG. 14: Almost the whole surface is light. |
| | | continuous surface | FIG. 15: At zooming up triangle lacunas of |
| | | of In | the initial surface can be seen (coating |
| | | | defects) |
| | | | FIG. 16: Elemental analysis of a light region |
| | | | shows that it consists of metallic In |
| 5 | 6 | Continuous | FIG. 17 Morphology of a granule after |
| | | homogeneous | encapsulation. |
| | | surface of In. | FIG. 18: At zooming up it can be seen that |
| | | | the lacunas of FIG. 15 are healed. |

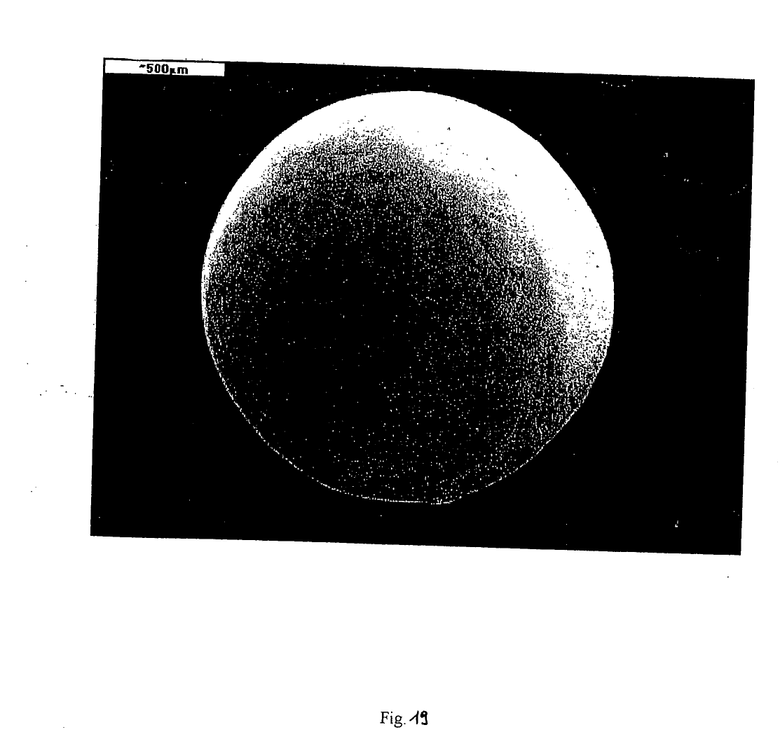

For comparison in FIG. 19 the morphology of Na₈In₁₁ granular with a diameter of 1.7 mm in an In-shell is shown. This granule was obtained by throwing a solid spherical particle down into a bath with glycerol at T₁=175° C. and Δh=200 mm (FIG. 6), which corresponds to approximately 1 second exposure in the given medium.

Conclusions from this example:
the stage of formation of a continuous protective coating is technologically important, after this moment the growth of the thickness of this coating becomes controllable (see Example 4);
the time period up to the appearance of continuous coating is determined by the temperature of liquid L and its chemical composition.

1. A method of obtaining protective coatings on a surface of chemically active materials comprising a mixture of a chemically active metal and a fusible stable element comprising the steps of:
providing at least one chemically active metal A;
providing at least one fusible stable element B;
mixing metal A and element B to form a mixture;
treating said mixture at its surface with a liquid agent L, wherein liquid agent L is capable of dissolving metal A but not capable of dissolving element B at a temperature which is higher than the melting point of element B thereby creating a coating consisting essentially of element B at the surface of said mixture;
ceasing treatment when a desired thickness of the coating is achieved;
removing the liquid agent;
cleaning the mixture; and
drying the mixture.

2. The method according to claim 1, wherein metal A is selected from the group consisting of alkali, alkali-earth, rare-earth metals and actinoids.

3. The method according to claim 2, wherein metal A is selected from the group consisting of lithium, sodium, potassium, rubidium, cesium, magnesium, calcium, strontium, barium, radium, lanthanum, praseodymium, erbium, europium, ytterbium, uranium, plutonium and thallium.

4. The method according to claim 1, wherein element B is selected from the group consisting of the elements in group III, IV, V and VI of the Periodic System and their binary and ternary combinations with each other.

5. The method according to claim 4, wherein element B is selected from the group consisting of gallium, indium, tin and their binary and ternary combinations with each other.

6. The method according to claim 1, wherein the liquid agent L is selected from the group consisting of (a) a substance having boiling point which is higher and a melting point which is lower than the melting point of element B, (b) mixtures of substances according to (a) and (c) solutions of substances according to (a) or their mixtures (b) in solvents which are neutral to both metal A and element B.

7. The method according to claim 6, wherein the liquid agent L is selected from the group consisting of CH-acids, aliphatic alcohols, polyhydric alcohols, higher carboxylic acids, condensed arenes polyethers, macrocyclic polyethers mixtures thereof, and solutions thereof.

8. The method according to claim 1, wherein ceasing treatment is accomplished by decreasing the temperature below the melting point of element B.

9. The method according to claim 1, wherein the thickness of the coating is 1 μm or more greater.

10. The method according to claim 1, wherein the thickness of the coating is being controlled by adjustment of duration and/or temperature of the treatment with liquid agent L.

11. The method according to claim 1, wherein the treatment comprises immersing the mixture of metal A and element B in liquid agent L.

12. The method according to claim 1, further comprising forming the mixture of metal A and element B into a desired shape before treatment with liquid agent L.

13. The method according to claim 12, wherein the mixture of metal A and element B is formed in essentially spherical shape.

14. The method according to claim 12, wherein the mixture of metal A and element B is formed in cylindrical form or in form of a plate.

15. The method according to claim 13, wherein the spherically formed mixture is dropped into a bath of liquid agent L.

16. A chemically active material with a protective coating on its surface obtained by the method of any one of claims 1 to 15.

17. (canceled)

18. The method according to claim 1, wherein the thickness of the coating is 10 μm or greater.

19. A method of manufacturing photoemissive devices and organic light emission diodes comprising using a chemically active material as a vapor source, wherein the chemically active material with a protective coating on its surface comprises a mixture of a chemically active metal and a fusible stable element and is produced by a method comprising the steps of:
providing at least one chemically active metal A;
providing at least one fusible stable element B;
mixing metal A and element B to form a mixture;
treating said mixture at its surface with a liquid agent L, wherein liquid agent L is capable of dissolving metal A but not capable of dissolving element B at a temperature which is higher than the melting point of element B thereby creating a coating consisting essentially of element B at the surface of said mixture;
ceasing treatment when a desired thickness of the coating is achieved;
removing the liquid agent;
cleaning the mixture; and
drying the mixture.

20. A method of manufacturing gas filters and vacuum sealed-off devices comprising using a chemically active material as chemisorbent including evaporable and non-evaporable getters, wherein the chemically active material with a protective coating on its surface comprises a mixture of a chemically active metal and a fusible stable element and is produced by a method comprising the steps of:
providing at least one chemically active metal A;
providing at least one fusible stable element B;
mixing metal A and element B to form a mixture;
treating said mixture at its surface with a liquid agent L, wherein liquid agent L is capable of dissolving metal A but not capable of dissolving element B at a temperature which is higher than the melting point of element B thereby creating a coating consisting essentially of element B at the surface of said mixture;
ceasing treatment when a desired thickness of the coating is achieved;
removing the liquid agent;
cleaning the mixture; and
drying the mixture.

21. A method of manufacturing special alloys, sublimation pumps or particle accelerators using a chemically active material as a source of active metals in chemical synthesis in the form of a catalyzer or in the form of a constituent of the produced product, wherein the chemically active material with a protective coating on its surface comprises a mixture of a chemically active metal and a fusible stable element and is produced by a method comprising the steps of:
providing at least one chemically active metal A;
providing at least one fusible stable element B;
mixing metal A and element B to form a mixture;
treating said mixture at its surface with a liquid agent L, wherein liquid agent L is capable of dissolving metal A but not capable of dissolving element B at a temperature which is higher than the melting point of element B thereby creating a coating consisting essentially of element B at the surface of said mixture;
ceasing treatment when a desired thickness of the coating is achieved;
removing the liquid agent;
cleaning the mixture; and
drying the mixture.
